(19) United States
(12) Patent Application Publication
(10) Pub. No.: US 2009/0159239 A1
(43) Pub. Date: Jun. 25, 2009

(54) VEHICLE HEAT EXCHANGER AND METHOD FOR SELECTIVELY CONTROLLING FUNCTIONS

(76) Inventors: Sameer Desai, Lake Orion, MI (US); Frank Suessemilch, Stuttgart (DE)

Correspondence Address: JULIA CHURCH DIERKER;DIERKER & ASSOCIATES, P.C., 3331 W. BIG BEAVER RD. SUITE 109, TROY, MI, 48084-2813, US

(21) Appl. No.: 11/963,821

(22) Filed: Dec. 22, 2007

(51) Int. Cl. F01P 11/00; F16K 31/44; F16L 37/00

(52) U.S. Cl. 165/71; 285/33; 251/349; 251/144

(57) ABSTRACT

A vehicle heat exchanger includes at least one end tank and a protruding fluid outlet formed integrally and in fluid communication with the at least one end tank. A push-connect fitting is configured to removably attach to the protruding fluid outlet, and to selectively perform at least a draining function.

### BACKGROUND

The present disclosure relates generally to vehicle heat exchangers and methods for selectively controlling functions.

Two goals for heat exchanger manufacturing often include forming a product that exhibits efficient transfer of heat, while maintaining a relatively simple manufacturing process. In the automotive industry, in particular, it has also become desirable to combine multiple functions into a single heat exchanger assembly. As such, multiple tubes, fins, manifolds and/or end tanks have been implemented into single heat exchanger assemblies.

Heat exchangers often include manifolds or end tanks that are formed of aluminum. Use of this and other like materials may provide some advantages in manufacturing and recycling. In some instances, however, such materials may also limit the types of features (e.g., fluid connectors, filler necks, oil cooler connections, mounting features, etc.) that are able to be formed integral with the manifolds and tanks. In order to include such features, additional steps may be required in the manufacturing process.

### BRIEF DESCRIPTION OF THE DRAWINGS

Features and advantages of embodiments of the present disclosure will become apparent by reference to the following detailed description and drawings, in which like reference numerals correspond to the same or similar, though perhaps not identical, components. For the sake of brevity, reference numerals having a previously described function may or may not be described in connection with subsequent drawings in which they appear.

FIG. 1A is a cut-away semi-schematic perspective view of an embodiment of the vehicle heat exchanger including an embodiment of a push-connect fitting attached to a protruding fluid outlet;

FIG. 1B is an exploded cut-away view of the push-connect fitting and protruding fluid outlet of FIG. 1A;

FIG. 1C is a cut-away cross-sectional view taken along the 1C-1C line of the protruding fluid outlet of FIG. 1B;

FIG. 2A is a cut-away semi-schematic perspective view of an embodiment of the vehicle heat exchanger including another embodiment of the push-connect fitting attached to a protruding fluid outlet;

FIG. 2B is an exploded view of the push-connect fitting and protruding fluid outlet of FIG. 2A;

FIG. 3 is a cut-away semi-schematic perspective view of an embodiment of the vehicle heat exchanger including another embodiment of the push-connect fitting having a tube attached thereto;

FIG. 4 is a semi-schematic perspective view of an embodiment the push-connect fitting including a connector and a drain cock;

FIG. 5 is a cut-away semi-schematic perspective view of an embodiment of the vehicle heat exchanger including another embodiment of the push-connect fitting attached to a protruding fluid outlet;

FIG. 6 is a cut-away semi-schematic front view of an embodiment of the vehicle heat exchanger including an embodiment of the push-connect fitting having an additional component attached thereto; and

FIG. 7 is a semi-schematic front view of an embodiment of a cooling module.

### DETAILED DESCRIPTION

Embodiments of the vehicle heat exchanger disclosed herein generally include an end tank, a protruding fluid outlet formed integrally and in fluid communication with the end tank, and a push-connect fitting that is removably attachable to the protruding fluid outlet. The push-connect fitting is advantageously capable of performing one or more functions, including a draining function. In some instances, the push-connect fitting may advantageously be formed of a polymeric material. Various embodiments of the vehicle heat exchanger are shown and discussed further hereinbelow in reference to the figures.

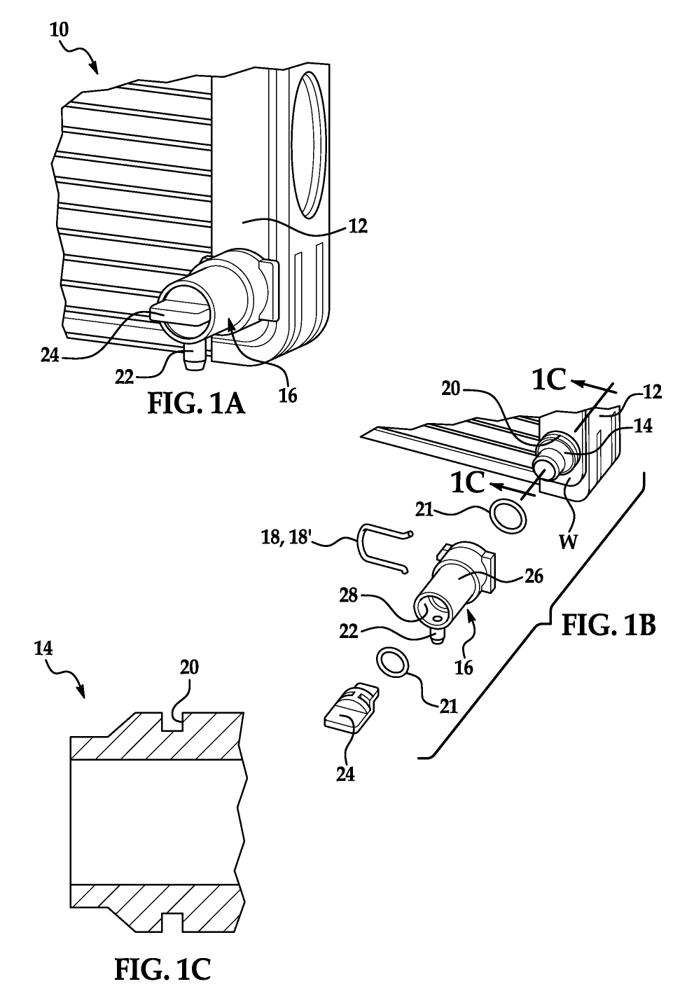

Referring now to FIGS. 1A and 1B together, an embodiment of the vehicle heat exchanger 10 is shown. The heat exchanger 10 includes at least one end tank 12, non-limiting examples of which include a bottom tank or a bottom most part of a tank. The end tank 12 may be formed of aluminum, aluminum alloys, copper, brass, or some other like material, or combinations thereof (e.g., copper brass). In some instances, the end tank 12 may be formed of polymeric materials.

The end tank 12 has a protruding fluid outlet 14 (see FIG. 1B) formed integrally therewith. The protruding fluid outlet 14 extends from an outer wall W of the end tank 12. It is to be understood that generally the protruding fluid outlet 14 is formed of the same material as the end tank 12. In non-limiting examples, the protruding fluid outlet 14 is stamped, cast, spinformed, or turned, and then is brazed onto the tank 12). The protruding fluid outlet 14 is in fluid communication with, and enables fluid to exit from, an interior the end tank 12. In some instances, fluid may be allowed to enter the heat exchanger 10 via the protruding fluid outlet 14. If the protruding fluid outlet 14 is positioned near a top of the tank 12, the outlet 14 may also be used to fill the end tank 12.

The protruding fluid outlet 14 may have any desirable size and/or configuration, as long as a push-connect fitting 16 may be removably attached thereto. In an embodiment, a sealing means 21 seals the connection between the protruding fluid outlet 14 and the push-connect fitting 16. A non-limiting example of such a sealing means 21 is an elastomeric O-ring. The push-connect fitting 16 is configured to selectively slide onto and off of the protruding fluid outlet 14. In one embodiment, the protruding fluid outlet 14 and push-connect fitting 16 may be configured such that the push-connect fitting 16 snaps into place over the protruding fluid outlet 14 without additional securing means. In another embodiment, the push-connect fitting 16 snaps into place over the protruding fluid outlet 14 because securing/releasing means (not shown) is integral with or previously installed on either the fitting 16 or the outlet 14. In still another embodiment, securing means 18 (such as a clip 18′ shown in FIG. 1B) may be used to secure the push-connect fitting 16 into place over the protruding fluid outlet 14. Other examples of suitable securing means 18 include snap-rings, e-rings, set-screws, integrated latches in the plastic, or the like, or combinations thereof.

FIG. 1C illustrates a cross-section of the protruding fluid outlet 14 taken along the 1C-1C line of FIG. 1B. As depicted, the protruding fluid outlet 14 may include a groove 20, which receives, for example, securing means 18 (a non-limiting example of which includes the clip 18′).

In the embodiment shown in FIGS. 1A and 1B, the push-connect fitting 16 is configured for a draining function. In this embodiment, the body 26 of the push connect fitting 16 generally defines a pathway 28 for fluid selectively exiting the end tank 12. The body 26 also defines a drain port 22 through which the fluid may be drained. The flow of fluid through the drain port 22 may be controlled via a drain cock or valve 24 operatively positioned within the body 26. The drain cock or valve 24 is configured such that when rotated into an open position, fluid is allowed to drain via the drain port 22, and when rotated into a closed position, fluid is occluded from draining via the drain port 22. In one embodiment, the drain cock or valve 24 is securely positioned within the body 26 via securing means 18, such as those previously described. Another sealing means 21 may be used to seal the valve 24. Generally, the drain cock or valve 24 may be controlled externally from the body 26.

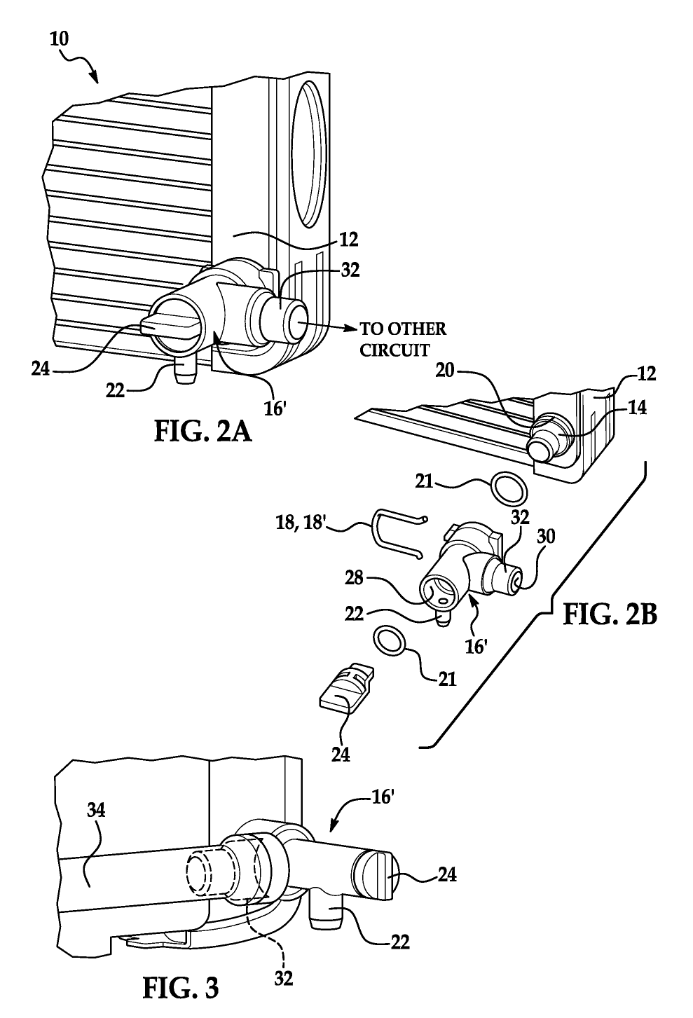

FIGS. 2A and 2B depict the vehicle heat exchanger 10 having another embodiment of the push-connect fitting 16′ removably attached to the protruding fluid outlet 14. It is to be understood that the push-connect fitting 16′ may be removably secured to the protruding fluid outlet 14 as previously described in reference to the push-connect fitting 16.

With the embodiment of the push-connect fitting 16′ shown in FIGS. 2A and 2B, multiple functions may advantageously be achieved with the single fitting 16′. In this embodiment, the push-connect fitting 16′ selectively drains fluid from the end tank 12 and conveys fluid from the end tank 12 to other fluid circuits (not shown) or from a fluid source (not shown) to the end tank 12. Non-limiting examples of such other fluid circuits include a water circuit, a hydraulic circuit, a transmission fluid circuit, an engine oil circuit, a power steering fluid circuit, or other like circuits.

In this embodiment of the push-connect fitting 16′, the body 26 generally defines a pathway 28 for fluid that is to be drained from the end tank 12, and another pathway 30 for fluid that is to be selectively conveyed to the other circuit or to the end tank 12 (from a fluid source). A drain port 22 is defined in the body 26 along the draining fluid pathway 28, and a fluid flow port 32 is defined in the body along the conveying fluid pathway 30. The drain port 22 and fluid flow port 32 may be the same size (e.g., both have the same diameter) or different sizes (e.g., each has a different diameter). As such, in some instances, the ports 22, 32 are configured to have the same flow rate, and in other instances, the ports 22, 32 are configured to have different flow rates.

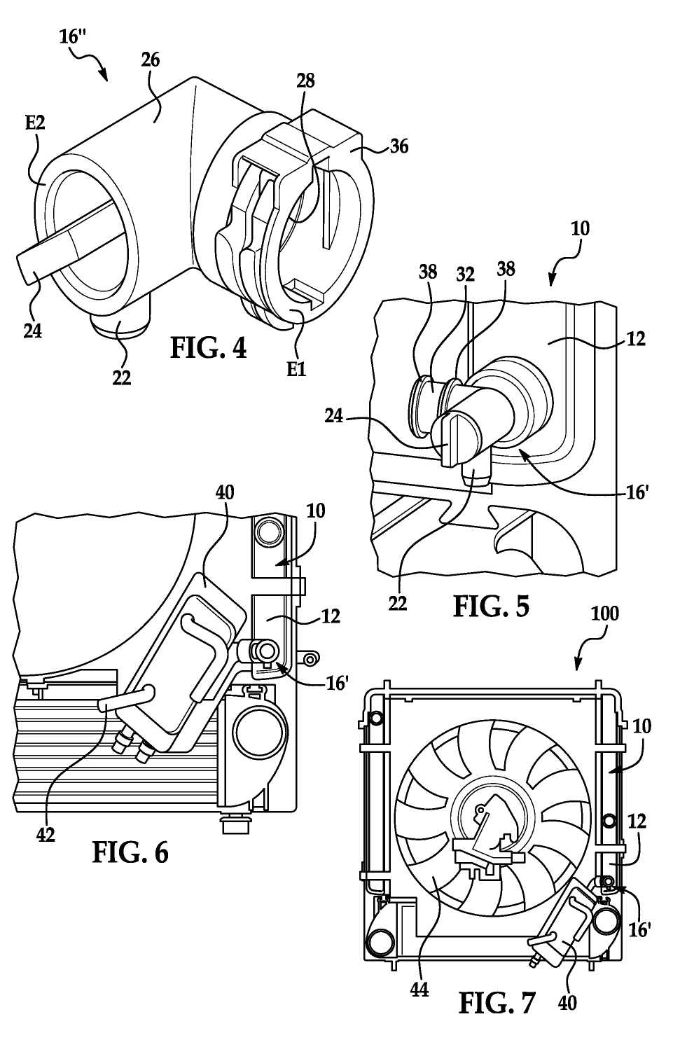

It is to be understood that the push-connect fitting 16′ (and the other embodiments of the push-connect fitting 16, 16″) may also be configured with multiple drain ports 22 and/or multiple fluid flow ports 32. In some instances, multiple fluid flow ports 32 may be desirable for conveying fluid to different fluid circuits via each port 32, or for filling and/or degassing the end tank 12 (i.e., if the outlet 14 is appropriately positioned for such functions) via one port 32 and conveying fluid to another circuit via another port 32. Furthermore, it is to be understood that the heat exchanger 10 may be configured with more than one protruding fluid outlet 14 and more than one push connect fitting 16, 16′, 16″ (16″ is shown in FIG. 4). As a non-limiting example, one fitting 16, 16′, 16″ may be used for coolant and another fitting 16, 16′, 16″ may be used for transmission fluid.

As shown in FIG. 2B, the drain cock or valve 24 is used to selectively control the draining function, as previously described.

In this embodiment, the push-connect fitting 16′ also includes a valve (not shown) that controls flow through the fluid flow port 32. Such fluid flow port valve(s) are generally positioned within the body 26, but are controllable externally from the body 26. In some instances, the fluid flow port valve(s) and/or the draining valve(s) 24 is/are manually controllable, and in other instances, the fluid flow port valve(s) and/or the draining valve(s) 24 is/are electronically controllable. Non-limiting examples of electronically controllable valves includes solenoid controlled spool or poppet valves. It is to be understood that other controls, such as wax-based thermal expansion valves, bimetallic thermostats or hydraulic pressure, may also be used to control the valves. The fluid flow port valve may be similar to the drain cock or valve 24 such that when in an open position, fluid is allowed to flow through the fluid flow port 32, and when in a closed position, fluid is occluded from flowing through the fluid flow port 32. It is to be understood that the fluid flow port valve may also be configured to control the flow rate of the fluid flowing therethrough. For example, the fluid flow port valve may be controlled to partially open, thereby variably throttling flow.

It is to be understood that the push-connect fitting 16′ may also includes a single valve that controls both the draining function and the fluid conveying function. For example, two occluding lands on a single shaft may be included. Such lands may be configured to occlude both ports 22, 32 at the same, or to occlude one port 22, 32 while opening the other port 32, 22.

Without being bound to any theory, it is believed that the use of the push-connect fitting 16, 16′ and the valves disclosed herein, multiple configurations of the heat exchangers 10 which support varying types of fluid circuits and fluid flow management are achievable.

FIG. 3 depicts a similar push-connect fitting 16′ as that shown in FIGS. 2A and 2B, with the fluid flow port 32 oriented in a different direction than that shown in FIGS. 2A and 2B. It is to be understood that the fluid flow port 32 may be oriented in any desirable direction. Such orientation may depend, at least in part, on the positioning of the other circuit and/or fluid source to which the fluid flow port 32 is to be connected.

FIG. 3 also depicts a tube 34 removably secured to the fluid flow port 32. The tube 34 may be used to fluidly connect the push-connect fitting 16′ to another circuit (not shown), or to connect the push-connect fitting 16′ to a fluid source. Such a tube 34 may be removably secured to the push-connect fitting 16′ prior to or subsequent to attaching the push-connect fitting 16′ to the protruding fluid outlet 14.

Referring now to FIG. 4, still another embodiment of the push-connect fitting 16″ is disclosed. This embodiment of the push-connect fitting 16″ has a body 26 with two opposed ends E1, E2. As previously described in reference to FIGS. 1A and 1B, the body 26 defines a draining fluid pathway 28 therein and a drain port 22 in fluid communication with the draining fluid pathway 28. In this embodiment, a connector 36 is formed integrally with one of the two ends E1 of the body 26. The connector 36 may include an interface and anti-rotation feature, such as, for example, that is a standard feature per the German Quality Management System (QMS) for the automobile industry (Verband der Automobilindustrie or VDA). It is to be understood that any other suitable connector 36 may be used, as long as it is complementary with the protruding fluid outlet 14. Furthermore, the other embodiments of the push-connect fitting 16, 16′ disclosed herein may include such a connector 36.

The push-connect fitting 16″ shown in FIG. 4 also includes a drain cock or valve 24 (as previously described) to selectively control the draining function.

In this embodiment, the ends E1, E2 are configured such that one end E1 is about 90° from the other end E2. When the connector 36 is secured to the protruding fluid outlet 14, the end E2 (and the drain cock or valve 24 operatively positioned therein) is positioned about 90° from the protruding fluid outlet 14. It is believed that this configuration enables relatively easy access to the drain cock or valve 24, as it extends outward at an angle relative to the protruding fluid outlet 14.

Referring now to FIG. 5, an embodiment of the push-connect fitting 16′ similar to that shown in FIGS. 2A and 2B is depicted. In this embodiment, the fluid flow port 32 includes multiple ribs 38 for receiving, for example, a hose 34 or an additional device 40 (a non-limiting example of which is shown in FIGS. 6 and 7). It is believed that the ribs 38 may advantageously provide a better seal (than a port 32 without the ribs) when the hose 34 is attached thereto and may advantageously improve retention of the hose 34. In a non-limiting example, the ribs 38 receive the hose 34 and a hose clamp (not shown) may be established over the hose 34, thereby enhancing the seal.

FIG. 6 illustrates the device 40 operatively connected to the fluid flow port 32 of the push-connect fitting 16′. In some instances, the device 40 may be any suitable device 40 to which it is desirable to convey fluid to from the end tank 12. Non-limiting examples of such devices 40 include heat exchanger(s), sensor(s), valves (e.g., control valves), thermostats or the like. In some instances, such devices 40 are integrated with (e.g., molded to) the push-connect fitting 16′ or the push-connect fitting 16′ is integrated with such devices 40.

It is to be understood that such devices 40 may include fluid lines 42 (e.g., transmission lines) to warm or cool fluids flowing therethrough. In a non-limiting example, the fluid lines 42 are capable of warming diesel fuel flowing therethrough in order to prevent the fuel from solidifying and/or to improve the overall performance through temperature regulation of the fuel.

FIG. 7 depicts an embodiment of a cooling module 100 including a fan 44 and the heat exchanger 10. In this embodiment, the push-connect fitting 16′ includes the drain port 22 and the device 40 operatively connected to the fluid flow port 32. It is to be understood that any of the push-connect fittings 16, 16′, 16″ may be used in the cooling module 100 of FIG. 7, depending, at least in part, on the desirable functionality of the selected fitting 16, 16′, 16″.

In any of the embodiments disclosed herein, the push-connect fitting 16, 16′, 16″ may be formed of a polymeric material. Any suitable method may be used to form such fittings 16, 16′, 16″, including, but not limited to injection molding. Other non-limiting examples of suitable methods for forming the fittings 16, 16′, 16″ include casting, compression molding, or two shot molding where the push-connect fitting 16, 16′, 16″ and sealing means 21 are made in a single process or on a single piece of equipment. In embodiments where the push-connect fitting 16, 16′, 16″ is made of metal, a suitable fabrication process includes casting.

While several embodiments have been described in detail, it will be apparent to those skilled in the art that the disclosed embodiments may be modified. Therefore, the foregoing description is to be considered exemplary rather than limiting.

What is claimed is:

1. A vehicle heat exchanger, comprising:
at least one end tank;
a protruding fluid outlet formed integrally and in fluid communication with the at least one end tank; and
a push-connect fitting configured to removably attach to the protruding fluid outlet, and to selectively perform at least a draining function.

2. The vehicle heat exchanger as defined in claim 1 wherein the push-connect fitting is configured to perform additional functions, one of which is to selectively convey a fluid to at least one conduit in a fluid circuit.

3. The vehicle heat exchanger as defined in claim 2 wherein the fluid circuit is a water circuit, a hydraulic circuit, a transmission fluid circuit, an engine oil circuit, or a power steering fluid circuit.

4. The vehicle heat exchanger as defined in claim 2 wherein the push-connect fitting further includes a valve or valves for controlling each of the draining and additional functions.

5. The vehicle heat exchanger as defined in claim 1 wherein the push-connect fitting further includes a drain cock for controlling the draining function.

6. The vehicle heat exchanger as defined in claim 1 wherein the push-connect fitting further includes a drain port.

7. The vehicle heat exchanger as defined in claim 6 wherein the push-connect fitting further includes a fluid flow port to allow fluid communication with a predetermined location.

8. The vehicle heat exchanger as defined in claim 7 wherein the drain port is configured such that fluid flows at a first flow rate, wherein the fluid flow port is configured such that fluid flows at a second flow rate, and wherein the first and second flow rates are the same or different.

9. The vehicle heat exchanger as defined in claim 1 wherein the push-connect fitting further includes a control valve, a heat exchanger, a sensor, or combinations thereof operatively connected thereto.

10. The vehicle heat exchanger as defined in claim 1 wherein the push-connect fitting further includes:
a body having two ends and defining a fluid pathway therein;
a connector formed integrally with one of the two ends of the body;
a drain cock positioned within an other of the two ends of the body; and
a drain port configured to selectively receive the drain cock;
wherein the connector is positioned about 90° relative to the drain cock.

11. The vehicle heat exchanger as defined in claim 1 wherein the push-connect fitting is formed of a polymeric material or a metal material.

12. A method for selectively controlling at least one function for a vehicle heat exchanger, the method comprising:
forming a protruding fluid outlet integrally and in fluid communication with at least one end tank;
removably attaching a push-connect fitting to the protruding fluid outlet; and
selectively occluding or enabling at least a draining function of the push-connect fitting.

13. The method as defined in claim 12 wherein the push-connect fitting is configured to perform additional functions, and wherein the method further comprises selectively conveying a fluid to at least one conduit in a fluid circuit via the push-connect fitting.

14. The method as defined in claim 13 wherein selectively conveying is controlled via a valve or valves of the push-connect fitting.

15. The method as defined in claim 12, further comprising occluding the draining function by configuring a drain cock of the push-connect fitting in a closed position.

16. The method as defined in claim 12, further comprising enabling the draining function by configuring a drain cock of the push-connect fitting in an open position.

17. The method as defined in claim 12 wherein the draining function is occluded, and wherein the method further comprises conveying a fluid to at least one conduit in a fluid circuit via a fluid flow port formed integrally with the push-connect fitting.

18. The method as defined in claim 12, further comprising operatively connecting a control valve, a heat exchanger, a sensor, a fluid conveying hose, or combinations thereof to the push-connect fitting.

19. The method as defined in claim 18 wherein operatively connecting is accomplished prior to removably attaching the push-connect fitting to the protruding fluid outlet.
